(19) United States
(12) Patent Application Publication
(10) Pub. No.: US 2016/0318014 A1
(43) Pub. Date: Nov. 3, 2016

(54) THIN WALLED PIPETTE TIP

(71) Applicant: Molecular Bioproducts, Inc., San Diego, CA (US)

(72) Inventors: Kemmons A. Tubbs, Mesa, AZ (US); Jesse B. Cohen, San Diego, CA (US)

(21) Appl. No.: 15/141,953

(22) Filed: Apr. 29, 2016

Related U.S. Application Data
(60) Provisional application No. 62/155,829, filed on May 1, 2015.

(51) Int. Cl. B01L 3/02

(52) U.S. Cl. CPC B01L 3/0275; B01L 2300/0832; B01L 2200/0689; B01L 2300/0681

(57) ABSTRACT

A pipette tip for use with a liquid handler is disclosed. The pipette tip includes a mandrel engaging portion positioned at a proximal end of the pipette tip and an elongated body extending distally from the mandrel engaging portion. The mandrel engaging portion includes an orifice at the proximal end of the pipette tip and an inner surface defining a lumen that is configured to engage a mandrel of a head of the liquid handler. The elongated body includes a proximal end portion adjacent the mandrel engaging portion, an intermediate portion, and a distal portion adjacent to an orifice at a distal end of the elongated body. The elongated body also includes an inner surface defining an interior cavity within the elongated body extending between the proximal end portion of the elongated body and the distal end. The elongated body has a wall thickness at the proximal end of the elongated body that does not exceed about 0.025 inches and a wall thickness adjacent the distal end that does not exceed about 0.01 inches. A microcolumn is positioned within the distal end portion of the elongated body.

### RELATED APPLICATION

The present non-provisional application claims priority to U.S. Provisional Application No. 62/155,829 filed May 1, 2015, the disclosures of which are hereby incorporated herein by reference in its entirety.

### FIELD

The present invention is directed to a pipette tip with an internal microcolumn and more particularly to a thin walled pipette tip having a sealed microcolumn for use with a liquid handler.

### BACKGROUND

High throughput screening allows for the processing and analysis of a large number of samples. Often times, high throughput screening requires extraction of a component from a sample containing a mixture of components. For example, it may be desirable to extract a protein fraction from a cellular extract or even a protein having affinity for a specific antibody from a mixture of other proteins and peptides. Extracting a desired fraction or component from a mixed sample may be accomplished with an extraction column. In high throughput screening, an extraction microcolumn is located at the distal end of the internal cavity of a pipette tip. Microcolumns tend to have limited capacity and flow rates due to restrictions on the diameter of the microcolumns due to the requirement that the microcolumn must fit inside the interior cavity of a pipette tip. Limits on the capacity and flow rates of microcolumns can also limit the speed with which high throughput screening can be accomplished. Microcolumns having improved capacity and flow rates, and thus shorter extraction times, are needed.

The capacity and flow rate of a microcolumn can be increased by increasing the diameter of the microcolumn. The diameter of the microcolumn is limited by the internal diameter of the cavity of the pipette tip in which the microcolumn is inserted. Typically, in order to increase the diameter of the internal cavity of a pipette tip, the wall defining the internal cavity must be displaced outwardly thereby increasing the outer diameter of the pipette tip.

Pipette tips are often stored in a container or assembly referred to as a rack until their use. Pipettes tips used with automated liquid handlers, such as robotic liquid handlers, are typically designed in racks that accommodate 96, 384, or 1536 arrays to correspond to the similar geometries the automated liquid handlers are designed to address. This rack configuration enables automatic liquid handlers the ability to accurately and reproducibly retrieve and form a seal with the pipette tips. Many automated liquid handlers have a plurality of mandrels situated adjacent to one another. The mandrels are typically spaced apart by a standardized distance to coordinate with the standard geometry utilized by equipment, devices, and consumables used in the field of biological research. The distance between pipette tips in racks used with such automated liquid handlers must match the distance between the mandrels on the liquid handler and coordinate on the deck with the standardized geometry. Accordingly, the outer diameter of a pipette tip placed in a rack is limited by the space between adjacent pipette tips, which corresponds with the space between the mandrels of the liquid handler. As discussed above, the diameter of a microcolumn inserted into a pipette tip is limited by the internal diameter of the pipette tip, which will be less than the outer diameter of the pipette tip. Thus, the diameter of a microcolumn inserted into a pipette tip that is stored in a rack is also limited by the spacing available in the storage rack, which can limit the capacity and flow rate of the microcolumn.

A problem associated with extraction pipette tips having microcolumns in the internal cavity is that the positive pressured applied to samples in the pipette tip can cause the sample to leak around the outside of the microcolumn instead of flowing through the microcolumn. In order to prevent leakage around the outside of the microcolumn, the inner surface of the pipette tip needs to form a seal with the external surface of the microcolumn. In high throughput screening applications, thousands of extraction pipette tips may be used in a short period of time. The failure of seals in even a small fraction of pipette tips could result in the need to re-analyze a significant number of samples, resulting in additional costs, and/or lack of reproducibility in a bioanalytical study. As such, methods are needed to improve the seal formed between the inner surface of a pipette tip and the external surface of a microcolumn, and thereby decreasing the failure rate of these seals.

### SUMMARY

Described herein is a pipette tip for use with a liquid handler (such as a semi-automated multichannel pipette). The pipette tip includes a mandrel engaging portion positioned at a proximal end of the pipette tip and an elongated body extending distally from the mandrel engaging portion. The mandrel engaging portion includes an orifice at the proximal end of the pipette tip and an inner surface defining an interior cavity. The inner surface of the mandrel engaging portion is configured to engage a mandrel located in the head of the liquid handler, such as an automated or semi-automated liquid handler. The elongated body includes a proximal end portion adjacent the mandrel engaging portion, an intermediate portion, and a distal portion adjacent to an orifice at the distal end of the elongated body. The elongated body also includes an inner surface defining an interior cavity within the elongated body extending between the proximal end portion of the elongated body and the distal end. The elongated body has a wall thickness at the proximal end of the elongated body that does not exceed about 0.025 inches and a wall thickness adjacent the distal end that does not exceed about 0.01 inches. A microcolumn is positioned within the distal end portion of the elongated body.

Various additional objectives, advantages, and features of the invention will be appreciated from a review of the following detailed description of the illustrative embodiments taken in conjunction with the accompanying drawings.

### BRIEF DESCRIPTION OF THE DRAWINGS

The accompanying drawings, which are incorporated in and constitute a part of this specification, illustrate embodiments of the invention and, together with a general description of the invention given above, and the detailed description given below serve to explain the invention.

FIG. 1 is a perspective view of a pipette tip in accordance with embodiments of the invention;

FIG. 2 is perspective cross-section side view of the device of FIG. 1;

FIG. 3 a longitudinal cross-section side view of the device of FIG. 1;

FIG. 4 is an exploded perspective view of the proximal end of the device of FIG. 1;

FIG. 5 is longitudinal cross-section side view of the device of FIG. 1 further including an upper filtration barrier and a microcolumn;

FIG. 6 is an exploded longitudinal cross-section side view of the distal end of the device of FIG. 5;

FIG. 7A is an exploded longitudinal cross-section side view of the distal end of an alternative embodiment of a pipette tip; and

FIG. 7B is an exploded longitudinal cross-section side view of the distal end of another alternative embodiment of a pipette tip.

### DETAILED DESCRIPTION

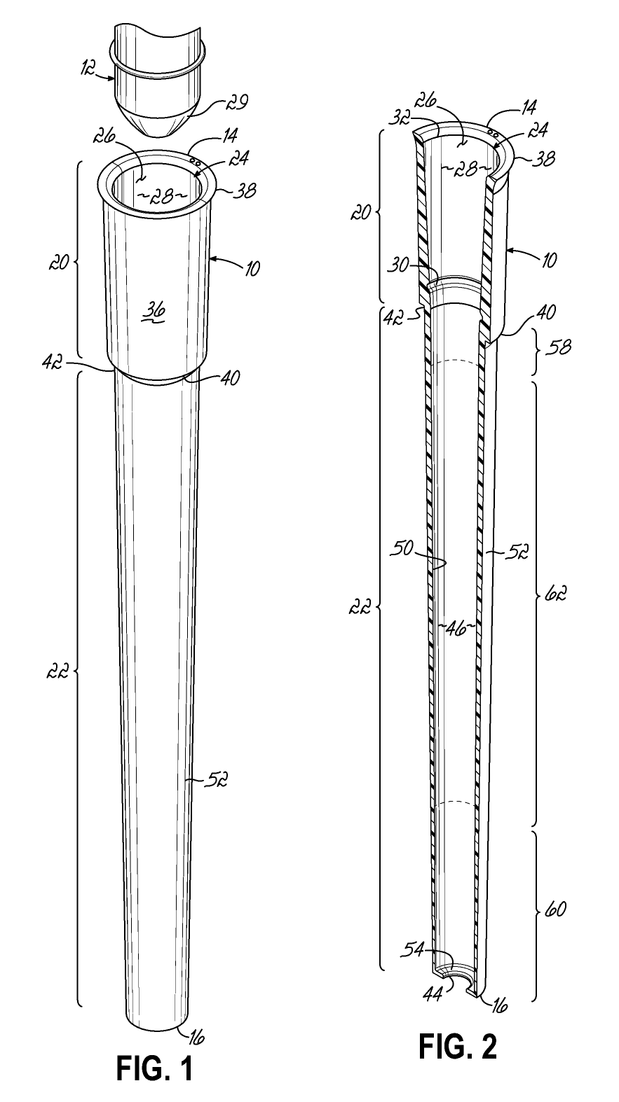

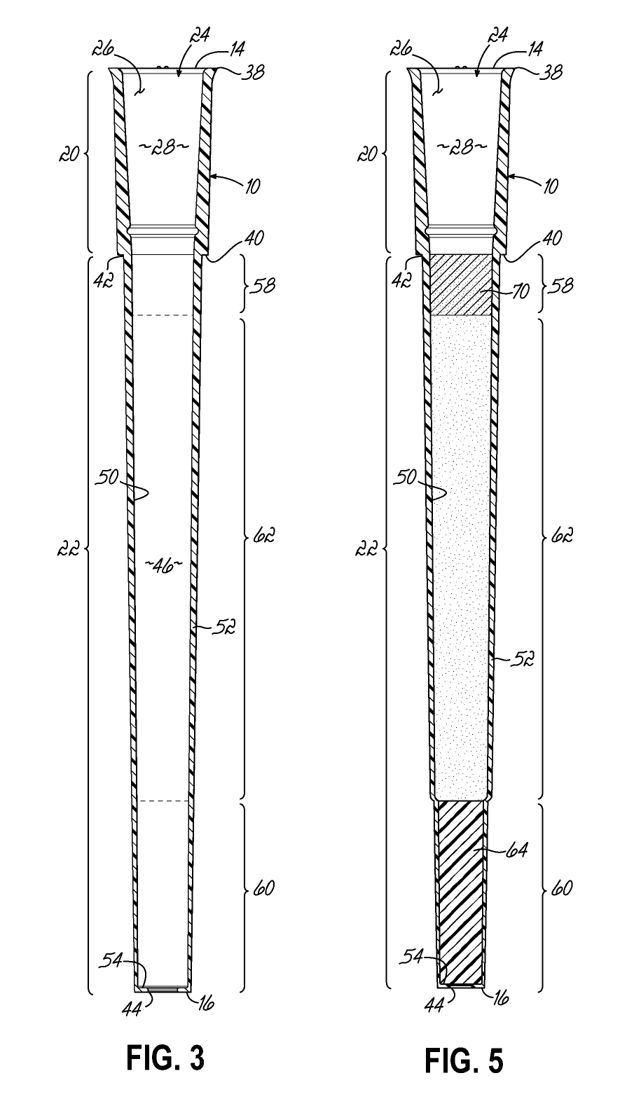

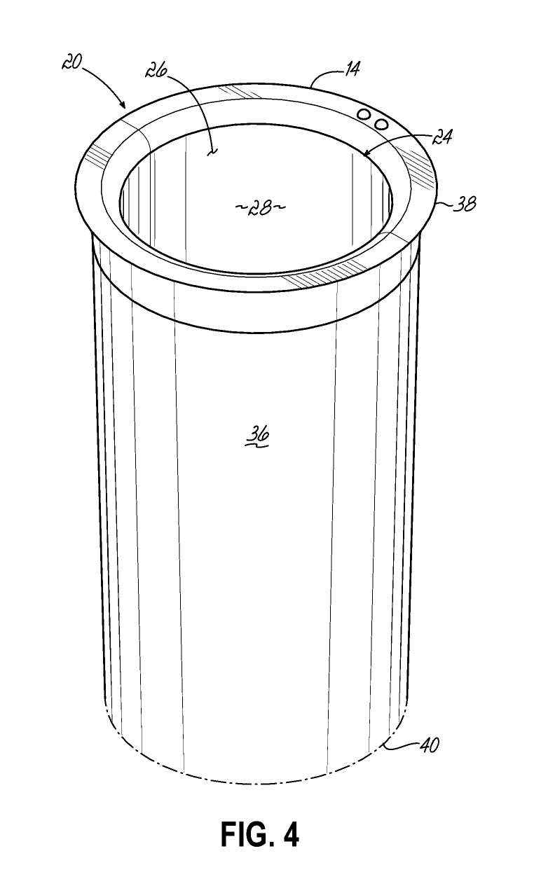

With reference to FIGS. 1 to 6, an embodiment of the invention is directed to pipette tip 10 for use with a liquid handler 12, and more particularly, for use with an automated liquid handler. The pipette tip 10 has a proximal end 14 and a distal end 16. A mandrel engaging portion 20 is positioned at the proximal end 14 of the pipette tip 10 and an elongated body 22 extends distally from the mandrel engaging portion 20.

With attention to FIGS. 1 to 4, the mandrel engaging portion 20 includes an orifice 24 at the proximal end 14 of the pipette tip 10 and an inner surface 26 defining a cavity 28. The inner surface 26 of the mandrel engaging portion 20 is configured to engage the outer surface of a mandrel 29 of a liquid handler 12. Exemplary liquid handlers include a manual pipette and automated liquid handling systems such as the robotic liquid handling systems marketed by Tecan®. In an embodiment, the inner surface 26 of the mandrel engaging portion 20 has a generally frustoconical shape that, when engaged with the mandrel 29 of a liquid handler 12, forms a seal with the mandrel 29. The inner surface 26 of the mandrel engaging portion 20 may have a taper in a range from about 2 degrees to about 4 degrees and alternatively, is about 3 degrees.

The inner surface 26 of the mandrel engaging portion 20 includes at least a first contact point 30 for forming a seal with the mandrel 29. The inner surface 26 may further include a second contact point 32 for the mandrel 29 that is either proximal or distal to the first contact point 30. In an embodiment, the second contact point 32 for the mandrel 29 is proximal to the first contact point 30. The second contact point 32 functions to stabilize the pipette tip 10 on the mandrel 29 to assist with maintaining the alignment of the pipette tip 10 during use. For example, the mandrel 29 used with some liquid handling systems includes an o-ring that contacts the inner surface 26 of the mandrel engaging portion 20. The alignment of the pipette tip 10 may pivot around this single contact point allowing the distal end 16 of the pipette tip 10 to become misaligned. The inclusion of a second contact point 32 on the inner surface 26 of the mandrel engaging portion 20 prevents the pipette tip 10 from pivoting around the o-ring contact point and decreases the likelihood that the distal end 16 of pipette will become misaligned during use. Maintaining the alignment of the distal end 16 of the pipette tip 10 within acceptable tolerances improves the operating efficiency of the liquid handler 12, especially automated liquid handlers, because it decreases the likelihood that pipette tips will become jammed during use and increases the accuracy of liquid administration by ensuring that liquid is administered to the desired location.

The proximal end 14 of the pipette tip 10 adjacent the orifice 24 in the mandrel engaging portion 20 may be flared, i.e., have a larger diameter immediately adjacent the proximal end 14 of the pipette tip 10 that transitions to a smaller diameter over short distance. The flared orifice makes it easier to eject the mandrel 29 of the liquid handler 12 from the orifice 24.

The mandrel engaging portion 20 has an outer surface 36 and a wall thickness between the inner and outer surfaces 26, 36. The wall thickness of the mandrel engaging portion 20 may increase from the proximal end 38 to the distal end 40 of the mandrel engaging portion 20. In an embodiment, the wall thickness ranges from about 0.02 inches to about 0.04 inches.

With attention to FIGS. 1-3, the pipette tip 10 includes an elongated body 22 that extends distally from the mandrel engaging portion 20. The elongated body 22 includes a proximal end 42 adjacent the mandrel engaging portion 20 and an orifice 44 at the distal end of the elongated body 22, which corresponds with the distal end 16 of the pipette tip 10. The elongated body 22 has in interior cavity 46 that is defined by the inner surface 50 of the sidewall 52 that forms the elongated body 22. The interior cavity 46 is in fluid communication with the interior cavity 28 of the mandrel engaging portion 20. The orifice 44 in the distal end of the elongated body 22 is in fluid communication with the orifice 24 at the proximal end 38 of the mandrel engaging portion 20 via the interior cavities 28, 46 of the elongated body 22 and the mandrel engaging portion 20.

The wall thickness of the sidewall 52 at the proximal end 42 of the elongated body 22 is greater than the wall thickness of the sidewall 52 at the distal end of the elongated body 22. In an embodiment, the wall thickness of the sidewall 52 at the proximal end 42 of the elongated body 22 does not exceed about 0.025 inches, or from about 0.02 inches to about 0.025 inches, or is about 0.021 inches. In an embodiment, the wall thickness of the sidewall 52 at the distal end of the elongated body 22 does not exceed about 0.01 inches, or from about 0.005 to about 0.01 , or is about 0.007 inches.

The elongated body 22 is generally frustoconical shaped and has a diameter at the proximal end 42 of the elongated body 22 that decreases along the length of the elongated body 22 to the distal end thereof. In an embodiment, the inner diameter near the proximal end of the elongated body 22 ranges from about 0.4 inches to about 0.6 inches, or from about 0.45 inches to about 0.55 inches, or is about 0.5 inches. The inner diameter near the distal end of the elongated body 22 may range from about 0.3 inches to about 0.02, inches or, in an alternative embodiment, from about 0.2 inches to about 0.01 inches, or, another alternative embodiment, about 0.13 inches. The internal cavity of the elongated may have an angle of convergence from the proximal end to the distal end that does not exceed about 0.03 degrees, or ranges from about 0.02 degrees to about 0.03 degrees.

The distal end of the elongated body 22 may include a shelf 54 that reduces the inner diameter of the orifice 44 at the distal end of the elongated body 22. In an embodiment, the inner diameter of the orifice 44 with the shelf 54 is about 0.02 inches less than the inner diameter of the interior cavity 46 of the elongated body 22 adjacent the shelf 54.

The elongated body 22 has a length measured along the central axis of the pipette tip 10 that is greater than the width of the elongated body 22 perpendicular to the central axis. The length of the elongated body 22 is also greater than the length of the mandrel engaging portion 20. The pipette tip 10 also has a length along its central axis measured from the distal end 16 of the pipette tip 10 to the proximal end 14 of the pipette tip 10 in a range from about 2 inches to about 3 inches, or about 2.2 inches to about 2.8 inches, or about 2.5 inches.

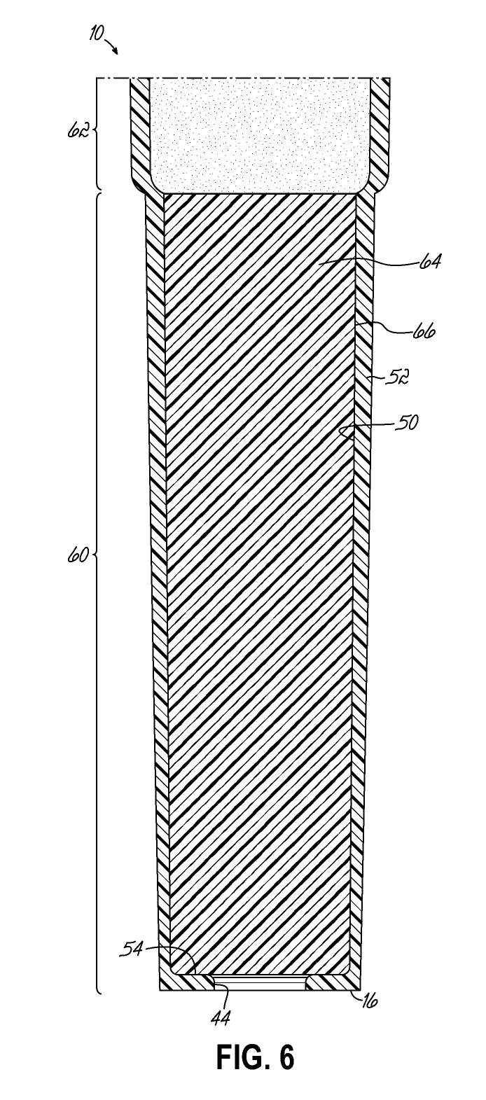

With attention to FIGS. 5 and 6, the elongated body 22 may have a proximal portion 58 adjacent the proximal end 42, a distal portion 60 adjacent the distal end, and an intermediate portion 62 between the proximal portion 58 and the distal portion 60. Embodiments of the pipette tip 10 includes a microcolumn 64 in the interior cavity 46 of the distal portion 60 of the elongated body 22. The microcolumn 64 is typically used for efficient capture and release of the desired component or fraction from the sample. Embodiments of the microcolumn 64 may include a solid-phase extraction medium, such as porous solid phase medium, or a plurality of non-porous beads that are packed into the column. The microcolumn 64 may also include one or more ligands having affinity for a specific component to be extracted from a sample.

The inner surface 50 of the elongated body 22 forms a fluid seal with the external surface 66 of the microcolumn 64 to prevent the leakage of material around the microcolumn 64 during use. If a good seal is not formed between the inner surface 50 of the elongated body 22 and the external surface 66 microcolumn 64, the positive pressure applied to the sample during use could result in the sample leaking around the external surface 66 of the microcolumn 64 thereby decreasing the operating efficiency of the microcolumn 64. The relatively thin thickness of the sidewall 52 of the elongated body 22 in the distal portion 60 assists with the formation of the seal between the inner surface 50 of the sidewall 52 and the external surface 66 of the microcolumn 64.

During the manufacture of embodiments of the pipette tip 10, a microcolumn 64 is inserted from the proximal end 14 of the pipette tip 10 into the distal portion 60 of the elongated body 22. The distal portion 60 of the elongated body 22 is then heated, such as by insertion into a heated mold, causing the sidewall 52 to shrink and reduce the inner diameter of the distal portion 60. The shrinkage of the sidewall 52 distal portion 60 results in the formation of a very good seal between the external surface 66 of the microcolumn 64 and the inner surface 50 of the elongated body 22. The very thin thickness of the sidewall 52 of the distal portion 60 elongated body 22 improves the efficiency with which the seal is formed and results in a much better seal as compared to heat seals formed with pipettes having a thicker sidewall. During the heating step, a cool nonreactive gas, such as nitrogen, may be flowed through the microcolumn 64 to prevent overheating that could damage the microcolumn 64.

Embodiments of the pipette tip 10 may optionally includes a barrier filter 70, such as a glass fiber filter, positioned in the interior cavity 46 of the proximal portion 58 of the elongated body 22. The barrier filter 70 prevents a sample or sample vapors from being aspirated into the liquid handler 12.

The pipette tip 10 is typically formed from a from a polymeric material via processes such as injection molding as are routine in the art. In an embodiment, the pipette tip 10 is formed from virgin polypropylene

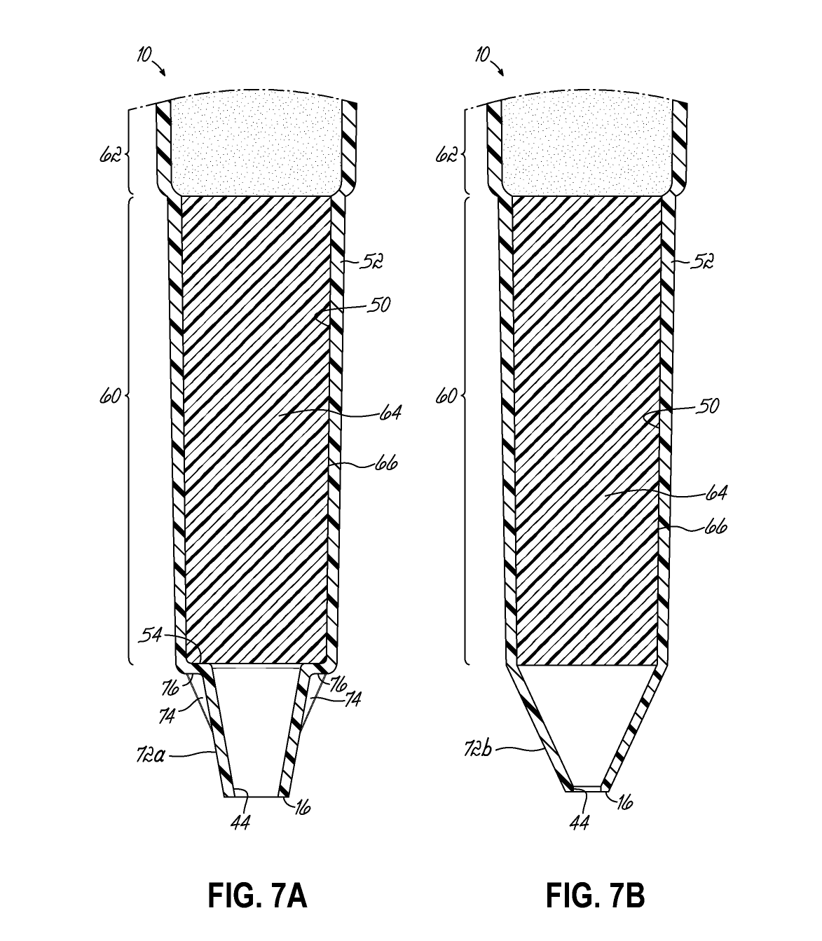

In the alternative embodiments illustrated in FIGS. 7A and 7B, the pipette tip 10 includes a conical extension 72a, 72b that projects from the distal portion 60 of the elongated body 22 to the orifice 44 in the distal end 16 of the elongated body. The extension 72a, 72b reduces the diameter of the orifice 44 at the distal end 16 of the pipette tip 10. In the embodiment illustrated in FIG. 7A, the extension 72a projects from the shelf 54. In the embodiment illustrated in FIG. 7B, the extension 72b projects from the sidewall 52. In embodiments of the invention, the extension 72a, 72b help align the distal ends 16 of pipette tips 10 with the holes of an array or with the holes in a rack when using the pipette tips 10 with an automated handler. Embodiments having an extension 72a projecting from the shelf 54, such as illustrated in FIG. 7A, may further include at least one guide fin 74 extending from the outer surface of the extension 72a and the outer surface 76 of the shelf to assist with guiding the pipette tip 10 into a hole by preventing the outer surface 76 of the shelf 54 from catching on the edge of the hole. The extensions 72a, 72b may also reduce the volume of residual liquid in the pipette tip 10 after the liquid has been expelled.

While the present invention has been illustrated by the description of one or more embodiments thereof, and while the embodiments have been described in considerable detail, they are not intended to restrict or in any way limit the scope of the appended claims to such detail. Additional advantages and modifications will readily appear to those skilled in the art. The invention in its broader aspects is therefore not limited to the specific details, representative apparatus and method and illustrative examples shown and described. Accordingly, departures may be made from such details without departing from the scope or spirit of the general inventive concept.

What is claimed is:

1. A pipette tip for use with a liquid handler comprising:
a mandrel engaging portion positioned at a proximal end of the pipette tip and an elongated body extending distally from the mandrel engaging portion,
wherein the mandrel engaging portion includes an orifice at the proximal end of the pipette tip and an inner surface defining a lumen, the inner surface being configured to engage a mandrel of a head of the liquid handler, and
further wherein the elongated body includes a proximal end portion adjacent the mandrel engaging portion, an intermediate portion, a distal portion adjacent an orifice at a distal end of the elongated body, an inner surface defining an interior cavity within the elongated body extending between the proximal end portion of the elongated body and the distal end, and a wall thickness at the proximal end of the elongated body that does not exceed about 0.025 inches and a wall thickness adjacent the distal end that does not exceed about 0.01 inches; and
a microcolumn positioned within the distal end portion of the elongated body.

2. The pipette tip of claim 1, wherein the interior cavity of the elongated body has an inner diameter at the proximal end in a range from about 0.2 inches and about 0.3 inches and an angle of convergence from the proximal end to the distal end that does not exceed about 3.5 degrees.

3. The pipette tip of claim 1 further comprising a conical extension projecting from the distal portion to the orifice at the distal end of the elongated body.

4. The pipette tip of claim 1, wherein the elongated body further includes a shelf at the distal end.

5. The pipette tip of claim 4 further comprising a conical extension projecting from the shelf between the distal portion and the orifice at the distal end of the elongated body.

6. The pipette tip of claim 5 further comprising at least one guide fin extending between the outer surface of the extension and the outer surface of the shelf.

7. The pipette tip of claim 1, further wherein an exterior surface of the microcolumn is sealingly engaged with an interior surface of the interior cavity of the distal portion of the elongated body.

8. The pipette tip of claim 1, further comprising a barrier filter positioned in the interior cavity of the proximal portion of the elongated body.

9. The pipette tip of claim 1, wherein the pipette tip has a length measured from the proximal end of the pipette tip to the distal end of the elongated body in a range from about 2 inches to about 3 inches.

10. The pipette tip of claim 9, wherein the length of the pipette tip is about 2.5 inches.
